(19) United States
(12) Patent Application Publication
(10) Pub. No.: US 2020/0389779 A1
(43) Pub. Date: Dec. 10, 2020

(54) ELECTRONIC DEVICE, INFORMATION PROVIDING SYSTEM, INFORMATION PROVIDING METHOD, AND RECORDING MEDIUM

(71) Applicant: SHARP KABUSHIKI KAISHA, Sakai City (JP)

(72) Inventor: KAZUYOSHI HADA, Sakai City (JP)

(21) Appl. No.: 16/890,527

(22) Filed: Jun. 2, 2020

(30) Foreign Application Priority Data
Jun. 7, 2019 (JP) 2019-107382

(51) Int. Cl. H04W 4/90

(52) U.S. Cl. CPC H04W 4/90; H04W 88/02

(57) ABSTRACT

An electronic device includes: an information acquiring unit configured to acquire content information indicating an attribute of each content; a notification information generating unit configured to generate content notification information notifying of recommended content that can be provided by referring to the content information; and an output control unit configured to control output of the content notification information. When the information acquiring unit acquires emergency information, the output control unit outputs emergency notification information notifying of the emergency information preferentially over the content notification information.

### CROSS-REFERENCE TO RELATED APPLICATION

The present application claims priority from Japanese Application JP2019-107382, the content to which is hereby incorporated by reference into this application.

### BACKGROUND OF THE INVENTION

### 1. Field of the Invention

The disclosure relates to an electronic device, an information providing system, an information providing method, and a recording medium, and relates to, for example, an information providing system for recommending various kinds of content based on a user's preference.

### 2. Description of the Related Art

In the related art, content recommending technologies in which an information providing apparatus connected to a network provides a terminal apparatus with information relating to content in accordance with a user's preference to have been proposed. For example, WO 2017/057010 discloses a control server that acquires any of status information used when a terminal apparatus outputs recommended information and operation history information of another terminal apparatus, and causes the terminal apparatus to output the recommended information in accordance with the acquired information. The terminal apparatus is further caused to display a recommendation screen, on which recommendation information is disposed in response to detection of a nearby user, and the recommendation screen includes a current date and a message relating to the current date, a weather forecast, an object for ending display of the recommendation screen and starting display of broadcast content, and an object for updating the recommended information. One piece of recommended information is information displaying associated information relating to recommended content in one object for selecting the recommended content, and the associated information includes an image representing an operation performed by the terminal apparatus in a case in which the recommended information is selected, the title of the content, an image representing the content, time information of the content, and a message indicating a reason for the recommendation.

### SUMMARY OF THE INVENTION

In general, an emergency situation such as a disaster, an accident, or the like may occur when a terminal apparatus is being used. When such an emergency situation occurs, it is desirable to make sure that emergency information that is provided from public organizations, such as the government or a local public organization, is distributed to residents. However, in content recommendation technologies of the related art, distribution of emergency information is not necessarily considered.

One aspect of the disclosure has been made in view of the foregoing, and an object of the disclosure is to provide an electronic device, an information providing system, an information providing method, and a recording medium that are able to provide emergency information more reliably when content is recommended.

The disclosure has been conceived to solve the above-described problem, and an aspect of the disclosure is an electronic device including an information acquiring unit configured to acquire content information indicating an attribute of each content, a notification information generating unit configured to generate content notification information notifying of recommended content that can be provided by referring to the content information, and an output control unit configured to control output of the content notification information, and when the information acquiring unit acquires emergency information, the output control unit outputs emergency notification information notifying of the emergency information preferentially over the content notification information.

According to this embodiment, when content is recommended, emergency information can be provided more reliably. For example, an appeal for an emergency to users and, as necessary, actions for evasion or prevention such as evacuation, or the like are encouraged more effectively.

### BRIEF DESCRIPTION OF THE DRAWINGS

FIG. 1 is a schematic block diagram illustrating an example of a functional configuration of an information providing system according to the present embodiment.

FIG. 2 is a block diagram illustrating an example of a functional configuration of an information providing apparatus according to the present embodiment.

FIG. 3 is a schematic block diagram illustrating an example of a hardware configuration of the information providing apparatus according to the present embodiment.

FIG. 4 is a diagram illustrating an example of tuning information according to the present embodiment.

FIG. 5 is a diagram illustrating an example of program information according to the present embodiment.

FIG. 6 is a diagram illustrating an example of channel-associated information according to the present embodiment.

FIG. 7 is a diagram illustrating an example of emergency information according to the present embodiment.

FIG. 8 is a diagram illustrating an example of emergency levels according to the present embodiment.

FIG. 9 is an example illustrating an example of ranks of recommended content.

FIG. 10 is a diagram illustrating an example of content card information according to the present embodiment.

FIG. 11 is a block diagram illustrating an example of a functional configuration of a terminal apparatus according to the present embodiment.

FIG. 12 is a diagram illustrating an example of display of images representing information of recommended content according to the present embodiment.

FIG. 13 is a diagram illustrating a first example of emergency card information according to the present embodiment.

FIG. 14 is a diagram illustrating a second example of emergency card information according to the present embodiment.

FIG. 15 is a diagram illustrating a third example of emergency card information according to the present embodiment.

FIG. 16 is a diagram illustrating a fourth example of emergency card information according to the present embodiment.

FIG. 17 is a diagram illustrating a first display example of emergency information according to the present embodiment.

FIG. 18 is a diagram illustrating a second display example of emergency information according to the present embodiment.

FIG. 19 is a diagram illustrating a third display example of emergency information according to the present embodiment.

FIG. 20 is a diagram illustrating a fourth display example of emergency information according to the present embodiment.

### DETAILED DESCRIPTION OF THE INVENTION

An embodiment of the disclosure will be described below with reference to the drawings.

### System Overview

First, an overview of an information providing system 1 according to the present embodiment will be described.

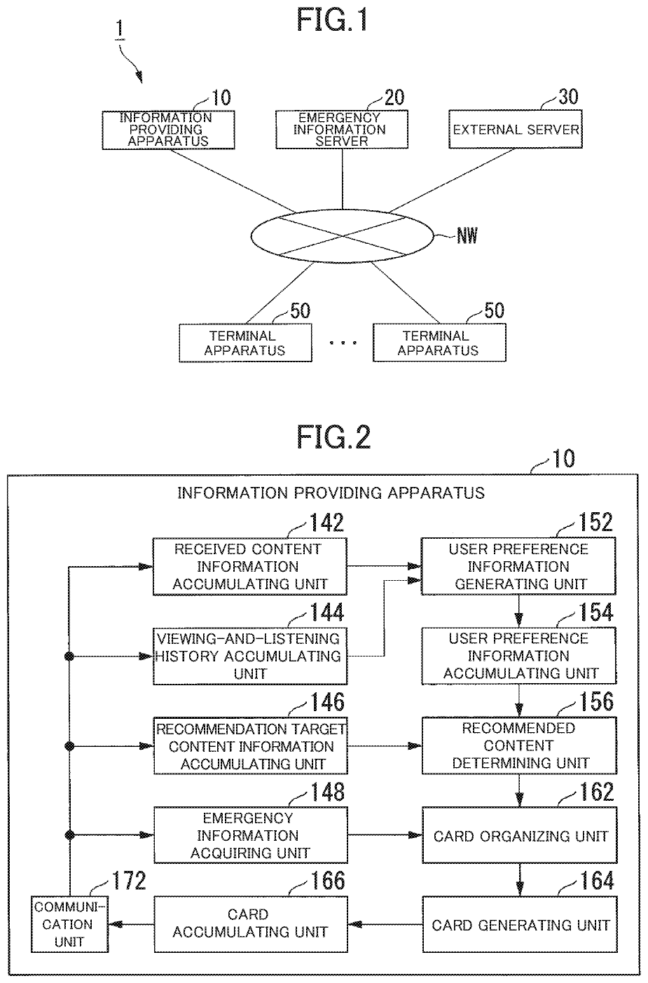

FIG. 1 is a schematic block diagram illustrating an example of a functional configuration of the information providing system 1 according to the present embodiment.

The information providing system 1 includes an information providing apparatus 10 connected to a network NW. The network NW is connected to an emergency information server 20, an external server 30, and terminal apparatuses 50, and allows various types of data to be transmitted and received among them in the information providing system 1.

The information providing apparatus 10 acquires content information indicating an attribute of each content from the external server 30 and refers to the acquired content information to generate content notification information relating to reception of recommended content that is allowed to be provided. The information providing apparatus 10 outputs the generated content notification information and transmits the information to the terminal apparatuses 50. The information providing apparatus 10 may analyze propensities of attributes of content received by the terminal apparatus 50, among content allowed to be provided, and select recommended content based on the propensities. The information providing apparatus 10 thus serves as a recommendation server. In the following description, the reception may be referred to as viewing-and-listening. Viewing-and-listening means one or both of visible display and audible playback for users.

When acquiring emergency information from the emergency information server 20, the information providing apparatus 10 generates emergency notification information for relaying the acquired emergency information. The information providing apparatus 10 preferentially outputs, to the terminal apparatuses 50, the generated emergency notification information over the content notification information.

Content includes any of videos, sounds, text, and the like, or a combination of them. Content may be, for example, a television broadcast program, video-on-demand (VOD) content, an advertising video, a piece of music, and the like. In the following description, content is mainly a television broadcast program and VOD content. The TV broadcast program is also referred to as a program. Recommended content is content that is recommended to a user of each terminal apparatus 50, and may be referred to as “recommended content.” The terminal apparatuses 50 serving as provision destinations may be an unspecified number of terminal apparatuses 50, or may be terminal apparatuses 50 of specific users who have entered into a predetermined contract.

The emergency information server 20 is a server apparatus that acquires emergency information indicating occurrence of an emergency situation. The emergency information server 20 generates emergency information in a predetermined format according to an operation signal input to the server. The emergency information server 20 receives emergency information from another device connected to the network NW. Emergency situations include, for example, natural phenomena such as rainfall, snowfall, a storm, an earthquake, river flood, storm waves, a tsunami, and the like, as well as cases caused by artificial factors such as a transportation failure, a power failure, fire, terrorism, and the like. An emergency situation is an event, among the above-described natural phenomena and accidents, in which damage to a tangible body, in particular, the body of an unspecified person, a matter, or the like, will occur or is highly likely to occur. Individual pieces of emergency information may include emergency level information indicating a degree of urgency. As emergency levels of emergency information relating to a natural disaster, for example, the levels of emergency disasters described in the “Guidelines on Evacuation Advisories” (http://www.bousai.go.jp/hinankankoku/hinanjumbijoho/index.html) provided by the Cabinet Office, for example, may be employed.

The emergency information server 20 transmits the acquired emergency information to the information providing apparatus 10.

The external server 30 is a server apparatus that transmits various types of information relating to content to the information providing apparatus 10 or the terminal apparatuses 50. Although the number of external servers 30 is one in the example illustrated in FIG. 1, the number may be more than one. The external server 30 may include, for example, a program collection server, a VOD content collection server, a VOD content server, and the like.

The program collection server is a server apparatus that acquires, from a server apparatus of a broadcaster, program information of programs that will be broadcast or have been broadcast on each broadcast channel and collects the acquired program information. The program collection server is, for example, a server apparatus for an Electronic Program Guide (EPG) provider. The program collection server transmits program information, which relates to a newly acquired program to be broadcast, to the information providing apparatus 10 at every predetermined time (e.g., one day). The program collection server also transmits program information, which relates to programs that have been broadcast, to the information providing apparatus 10.

The VOD content collection server is a server apparatus that sequentially acquires, from a server apparatus of a content provider, VOD content information relating to VOD content that can be transmitted and has been transmitted, and collects the acquired VOD content information. The VOD content collection server transmits to the information providing apparatus 10 newly acquired VOD content information every predetermined time (e.g., one day). The VOD content collection server also transmits, to the information providing apparatus 10, VOD content information relating to VOD content that has been transmitted to any terminal apparatus 50. Note that, in the following description, meta information of individual content such as program information, VOD content information, and the like will be collectively referred to as content information. Server apparatuses that provide content information, such as a program collection server or a VOD content collection server, will be collectively referred to as a content information server. The content information server may transmit content information relating to content that has been transmitted in response to a transmission request from the information providing apparatus 10, or may transmit the content information at any time.

The VOD content server is a server apparatus that stores content data of various types of VOD content. The VOD content server reads content data of VOD content indicated by a VOD content request received from the terminal apparatus 50. Such content data includes video data constituting VOD content. The VOD content server transmits the read content data to the terminal apparatus 50, which serves as a transmission source, in response to the VOD content request.

The terminal apparatus 50 performs processing, primarily, for recommended content reception service. Processing for the reception service includes, in a case where the recommended content is a program, receiving broadcast waves of a channel on which the program is broadcast, or receiving and recording program data of the program at a reserved time designated by the user. The terminal apparatus 50 acquires card information including reception information relating to the reception of the recommended content. For example, in a case in which the recommended content is a program, the reception information includes the broadcast channel of broadcast waves carrying program data and the broadcast time. In a case in which the recommended content is VOD content, for example, the reception information includes the address, the file name, and the like of the VOD content server storing the content data of the recommended content. In addition, the terminal apparatus 50 controls whether to output content notification information indicating the recommended content based on a priority thereof depending on whether the content is within a validity period. The terminal apparatus 50 performs a function of receiving the recommended content in response to an instruction given by an operation on an image representing the recommended content as content notification information. For example, the terminal apparatus 50 receives broadcast waves based on the reception information, acquires program data carried on the received broadcast waves, and outputs to a display unit video data included in the acquired program data. However, when emergency notification information is acquired from the information providing apparatus 10, the terminal apparatus 50 outputs the acquired emergency notification information preferentially over the content notification information. The terminal apparatus 50 may also determine the priority of the output based on an emergency level given to the emergency notification information, or may decide a display form according to the emergency level.

The terminal apparatus 50 may be configured of dedicated hardware, and in a case where the terminal apparatus includes a broadcast receiving unit that receives broadcast waves, a communication unit that can transmit and receive various types of data to and from various other electronic devices via the network NW, a display unit that displays various types of content, and an input unit that accepts an operation input, the terminal apparatus may perform processing according to a command described in a prescribed program on general-purpose hardware including various processors and memories thereby implementing the functions of the terminal apparatus 50. Note that, in the following description, performing the processing according to a command described in a program will be referred to as “executing a program.”

### Information Providing Apparatus

Next, a configuration of the information providing apparatus 10 according to the present embodiment will be described.

FIG. 2 is a block diagram illustrating an example of a functional configuration of the information providing apparatus 10 according to the present embodiment.

The information providing apparatus 10 includes a received content information accumulating unit 142, a viewing-and-listening history accumulating unit 144, a recommendation target content information accumulating unit 146, an emergency information acquiring unit 148, a user preference information generating unit 152, a user preference information accumulating unit 154, a recommended content determining unit 156, a card organizing unit 162, a card generating unit 164, a card accumulating unit 166, and a communication unit 172.

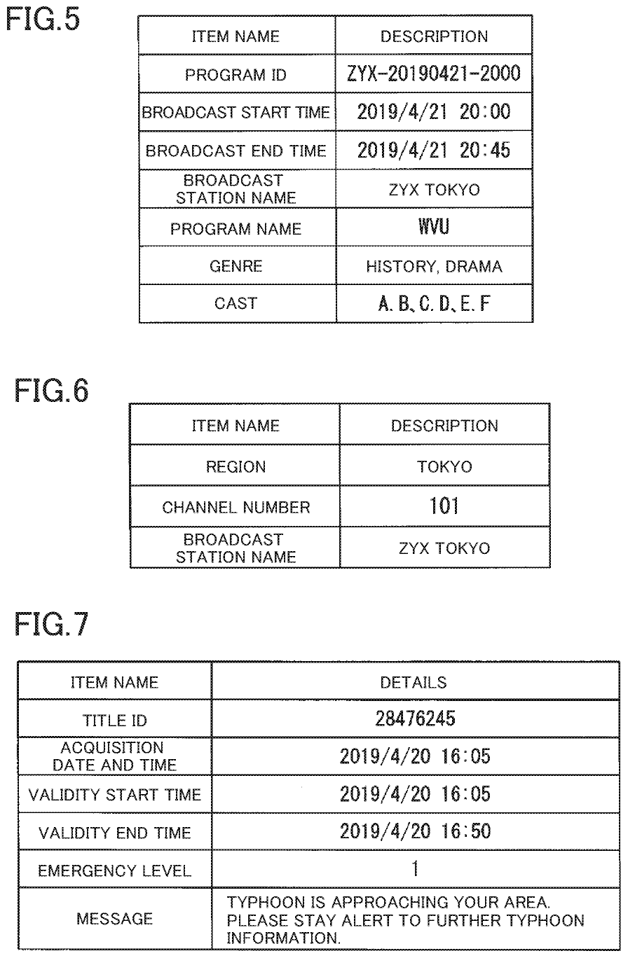

The received content information accumulating unit 142 acquires content information from the external server 30 by using the communication unit 172 and accumulates the acquired content information. The content information acquired by the received content information accumulating unit 142 is content information relating to content that the terminal apparatus 50 has previously received. The received content information accumulating unit 142 acquires program information as content information from, for example, the program collection server. As illustrated in FIG. 5, for example, the program information may be configured as metadata indicating information including, for each program, a program ID (Identifier), a broadcast start time, a broadcast end time, a broadcast station name, a program name, a genre (field), and a cast (performers). The broadcast start time and the broadcast end time are information indicating broadcast times. The received content information accumulating unit 142 also acquires, for example, VOD content information as content information from the VOD content collection server. The VOD content information is configured as metadata (not illustrated) indicating information including, for each piece of VOD content, for example, a content ID, acquisition source information, a playback time, a publication start time, a publication end time, a producer name, a sponsor name, a title, a genre, and a cast. The acquisition source information is, for example, a Uniform Resource Locator (URL) of a VOD content server apparatus capable of transmitting the VOD content. The URL may also include information of the directory with regard to storage of VOD content data of the VOD content. The publication start time and the publication end time are times at which a state of the server apparatus capable of transmitting the VOD content begins and a state of the server apparatus capable of transmitting the VOD content ends, respectively.

The viewing-and-listening history storage unit 144 acquires tuning information from the terminal apparatuses 50 by using the communication unit 172, sequentially accumulates the acquired tuning information, thereby forming a program viewing-and-listening history for each terminal apparatus 50. As illustrated in FIG. 4, for example, the tuning information is information including a user ID, a region, a channel number, a viewing-and-listening start time, and a viewing-and-listening end time. The user ID represents information for identifying a user of the terminal apparatus 50. A device ID of the terminal apparatus 50 may be used instead of the user ID. The region represents a region in which the program is broadcast. The channel number represents the number of the broadcast channel on which the program is broadcast. The viewing-and-listening start time and the viewing-and-listening end time represent a reception time at which the program is received. There are cases in which the viewing-and-listening start time or the viewing-and-listening end time may be a time during a broadcast time of the program. Such cases include a case in which a user indicates switching to another program during broadcasting, i.e., a case in which another program (e.g., a Commercial Advertisement (CM), a program advertisement, or the like) is inserted into one program, or the like. As such, the broadcast time of a certain program may not be associated with a reception time thereof in a one-to-one manner, but may also be divided into multiple consecutive time blocks.

The viewing-and-listening history accumulating unit 144 refers to the channel-associated information stored in advance therein to identify a broadcast station name corresponding to the channel number and the region indicated by the tuning information as a broadcast station on which the program is broadcast. As illustrated in FIG. 6, for example, the channel-associated information is information in which a region, a channel number, and a broadcast station name are associated with one another.

Then, the viewing-and-listening history accumulating unit 144 can identify the program name, the broadcast station of which matches the identified broadcast station name, and the reception time of which is included in the broadcast time, as a program name of a program received during the reception time.

Note that the viewing-and-listening history accumulating unit 144 sequentially accumulates VOD selection information acquired from the terminal apparatus 50, and forms a VOD viewing-and-listening history for each of the terminal apparatuses 50. The VOD selection information is information (not illustrated) including a user ID, a content ID, a viewing-and-listening start time, and a viewing-and-listening end time. The content ID represents information for identifying each piece of VOD content.

Returning to FIG. 2, the recommendation target content information accumulating unit 146 acquires content information relating to content that may be recommended through the communication unit 172 from the external server 30, and accumulates the program information and VOD content information as the acquired content information. Here, content that may be recommended may be, to exemplify programs, a program that is scheduled to be broadcast within a predetermined period of time in the future, e.g., two days later than that time, the two days being, for instance from 5 a.m. the next morning to 5 a.m. of the day after the next day. Recommended content is selected from programs that are scheduled to be broadcast during this time period. Since program information is sequentially accumulated in the recommendation target content information accumulating unit 146 according to channels and broadcast times, the program information is formed as part of the content information to be recommended. The program information acquired by the recommendation target content information accumulating unit 146 differs from that of the received content information accumulating unit 142 that acquires program information relating to a program that has been viewed and listened to in that the former is program information relating to a program that is scheduled to be broadcast in the future. The recommendation target content information accumulating unit 146, after broadcasting of a program is completed, duplicates (copies) the program information of the program, stores the duplicated program information in the received content information accumulating unit 142, and removes the program information stored therein. In this case, the program collection server, which is the external server 30, may omit transmitting to the information providing apparatus 10 the program information relating to the broadcast program.

The VOD content information acquired by the recommendation target content information accumulating unit 146 differs from that of the received content information accumulating unit 142 that acquires VOD content information relating to a VOD that has been viewed and listened to in that the former is VOD content information relating to VOD content that can be transmitted in the future. The recommendation target content information accumulating unit 146 may reproduce VOD content information relating to the VOD content received by any terminal apparatus 50 and store the VOD content information in the received content information accumulating unit 142. The recommendation target content information accumulating unit 146 can identify the receiving terminal apparatus 50 and the received VOD content with reference to a VOD viewing-and-listening history stored in the viewing-and-listening history accumulating unit 144. In this case, the VOD content collection server may omit transmitting to the information providing apparatus 10 the VOD content information relating to VOD content that has been transmitted. When a current time exceeds a predetermined transmission period for the VOD content, the recommendation target content information accumulating unit 146 erases the VOD content information stored therein. Information of the predetermined transmission period may be included in the VOD content information. Alternatively, a publication start time and a publication end time may be used as information for the transmission period.

The emergency information acquiring unit 148 acquires the emergency information from the emergency information server 20 using the communication unit 172. In a case in which the emergency information server 20 transmits new emergency information spontaneously to the information providing apparatus 10, the emergency information acquiring unit 148 waits for emergency information from the emergency information server 20. The emergency information acquiring unit 148 transmits, to the emergency information server 20, an emergency information query signal indicating acquisition of new emergency information every predetermined time interval (e.g., 15 seconds to 3 minutes) by using the communication unit 172. The emergency information acquiring unit 148 receives response information as a response to the emergency information query signal from the emergency information server 20. The emergency information acquiring unit 148 extracts new emergency information from the response information when the received response information indicates the presence of the new emergency information.

FIG. 7 illustrates a message representing emergency information. The metadata includes the title ID, acquisition date and time, validity start time, validity end time, emergency level, and message. In this application, the emergency information to which the metadata is given may be simply referred to as emergency information.

The title ID is identification information for identifying individual pieces of emergency information. As the title ID, an emergency information ID assigned by a provision source of the emergency information may be used, or a title ID assigned uniquely by the emergency information acquiring unit 148 may be used. The acquisition date and time is date and time at which the emergency information is acquired. The acquisition date and time may describe the date and time on which the emergency information is issued. The validity start time and the validity end time are start time and end time of the validity period of the emergency information, respectively. The emergency level is indicated by a value indicating a level of urgency. A higher emergency level indicates a greater need for the user to receive the emergency information. A high level of urgency may include a high level of need to swiftly deal with an emergency situation and a high level of need to avoid or mitigate possible damage. The message indicates information of a state in which an emergency situation has occurred, a measure to deal with the emergency situation (e.g., an evacuation method, a source of associated information), or the like.

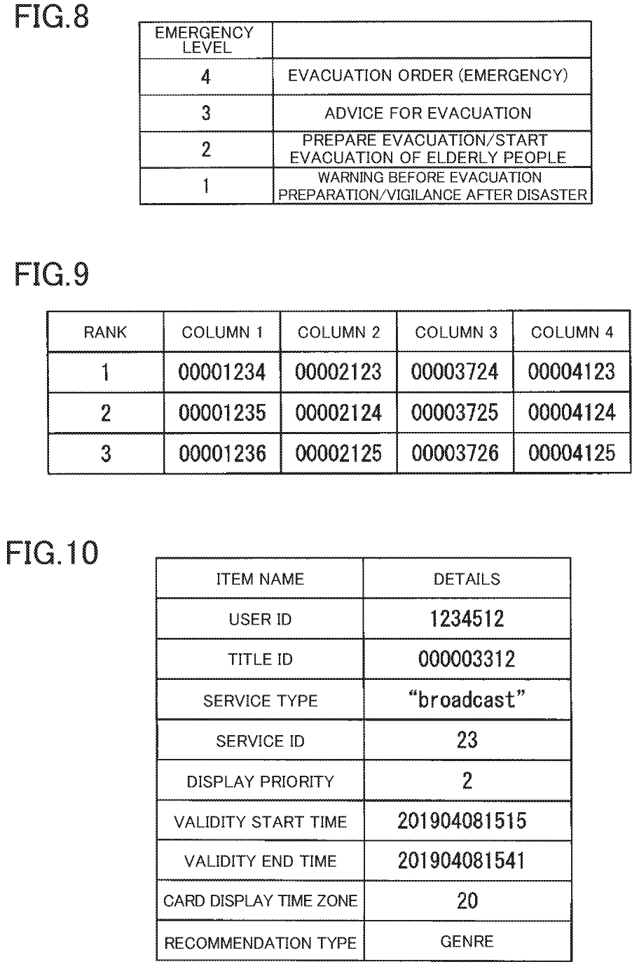

FIG. 8 illustrates an example of emergency levels. The emergency levels illustrated in FIG. 8 are indicated by integer values based on order of levels of emergence disasters described in the “Guidelines on Evacuation Advisories” provided by the Cabinet Office, and greater values thereof indicate higher levels of urgency. The emergency level “1” indicates “warning before evacuation preparation” or “vigilance after disaster” as an emergency situation. That is, the emergency level “1” indicates a stage in which merely emergency information, such as an alert is provided and the situation is allowed not to take a specific measure against the emergency situation. The emergency level “2” indicates “prepare evacuation” or “start evacuation of elderly people.” That is, the emergency level “2” indicates a stage in which a notification of preparation for an emergency situation is given or a notification of the urgency of the emergency situation is made to elderly people, children, pregnant women, foreigners, and the like who are called people vulnerable to disasters. The emergency level “3” indicates “official advice for evacuation.” That is, the emergency level “3” is a stage in which a notification for addressing an emergency situation and a possibility of damage unless addressed properly is made to relevant residents. The emergency level “4” indicates “evacuation order.” That is, the emergency level “4” is a stage in which swift addressing of the emergency situation is ordered to relevant residents. Note that the number of stages of the emergency levels, definitions of the stages, and the like may be set optionally by a provider of the emergency information.

The emergency information acquiring unit 148 outputs the acquired emergency information to the card organizing unit 162.

Returning to FIG. 2, the user preference information generating unit 152 reads a program viewing-and-listening history of each of the terminal apparatuses 50 from the viewing-and-listening history accumulating unit 144, and reads the program information of each program indicated by the read program viewing-and-listening history from the received content information accumulating unit 142. The user preference information generating unit 152 refers to the read program information, and analyzes a viewing-and-listening quantity of the program having attributes relating to user preference, for each of the attributes. Attributes relating to preferences include cast, genre, program name, and the like. The user preference information generating unit 152, for example, cumulates reception times of programs received for each cast within a predetermined cumulative period (e.g., one month to six months), and calculates a cumulative viewing-and-listening quantity. The user preference information generating unit 152 calculates the viewing-and-listening quantity for each genre and program name in a similar manner to the processing performed for the cast. The user preference information generating unit 152 causes the viewing-and-listening quantity to be arranged, in descending order, for each item (i.e., cast, genre, and program name) for each type of attribute. The user preference information generating unit 152 may select, from the arranged viewing-and-listening quantity, the type of attribute according to the viewing-and-listening quantity of each of the predetermined number of items (e.g., five items ranked in the first to fifth positions) for each type of attribute, and discard the type of attribute according to the viewing-and-listening quantity of the other items. Thus, what attribute of a program the user of the terminal apparatus 50 prefers can be analyzed. The user preference information generating unit 152 generates, for each terminal apparatus 50, user preference information indicating items for each type of selected attribute, and stores the generated user preference information in the user preference information accumulating unit 154.

Note that the user preference information generating unit 152 also creates user preference information on VOD content for each terminal apparatus 50 in a manner similar to that of programs, and stores the created user preference information in the user preference information accumulating unit 154. In this case, the user preference information generating unit 152 uses the VOD viewing-and-listening history and the VOD content information in place of the program viewing-and-listening history and the program information.

The user preference information accumulating unit 154 stores the user preference information generated by the user preference information generating unit 152. The user preference information accumulating unit 154 may delete the user preference information that is referred to define recommended content by the recommended content determining unit 156.

The recommended content determining unit 156 reads the user preference information for each terminal apparatus 50 from the user preference information accumulating unit 154. The recommended content determining unit 156 determines recommended content candidates from content relating to content information accumulated in the recommendation target content information accumulating unit 146 by using the read user preference information. The recommended content candidates will be referred to as candidate content below.

Using items associated with predetermined recommendation types as keys, among the attributes, for example, genre, cast, and the like, the recommended content determining unit 156 gives a higher score to a program including a greater number of information elements that match the items. The score may be a value normalized in a predetermined range of values (e.g., 0 to 100). The score is used as an index of priority with regard to transmission to the terminal apparatus 50 as described below. The recommended content determining unit 156 gives, to the content information of individual candidate content, a predetermined score for each candidate content and outputs the content information to the card organizing unit 162.

The card organizing unit 162 selects, as recommended content, the number of which is equal to the number of pieces of predetermined card information that the terminal apparatus 50 can receive and can present at one time, for each block (or time block) of a predetermined unit time (e.g., 10 to 60 minutes) from candidate contents relating to the content information input from the recommended content determining unit 156. The card organizing unit 162 preferentially selects, as recommended content, a candidate content having a higher score for each of the service types of candidate content. The service type means a type of service form for the user of the terminal apparatus 50. The service type includes, for example, broadcast, reservation, and VOD. Broadcast is a service in which program data of a program broadcast at that time is received and content such as video and audio content relating to the received program data is presented at that time. Reservation is a service in which program data of a program to be broadcast is received and recorded at specified times. VOD is a service in which VOD content that can be transmitted at that time is requested, the VOD content data of the requested VOD content is received, and content relating to the received VOD content data is presented at that time.

The card organizing unit 162 may determine the rank of each service type in descending order of scores of individual recommended contents, and include the rank of each service type of each slot in the content information. The card organizing unit 162 outputs the content information for each selected recommended content to the card generating unit 164.

FIG. 9 illustrates an example of ranks determined by the card organizing unit 162. In the example illustrated in FIG. 9, each column is assigned for each service type. Column 1 and column 2 are assigned for VOD as service type, column 3 is assigned for broadcast, and column 4 is assigned for reservation. Each row indicates the rank for each column. The upper rows indicate higher ranks and the lower rows indicate lower ranks. In the field of each row and column, a content ID indicating an individual recommended content is described.

However, in a case in which emergency information is input from the emergency information acquiring unit 148, the card organizing unit 162 preferentially outputs to the card generating unit 164 the input emergency information over content information relating to another recommended content. In other words, instead of outputting the emergency information, the card organizing unit 162 stops outputting to the card generating unit 164 the content information relating to part or all of the selected recommended content. Also, as emergency information has a higher emergency level, the card organizing unit 162 may reduce further the number of recommended content, of which the content information is to be output to the card generating unit 164. The card organizing unit 162 may stop outputting the content information relating to the recommended content when the emergency level is at or above a predetermined level (e.g., level 3).

With respect to the name of a card or card information, information of the recommended content is displayed in the terminal apparatus 50 as a card-shaped image as an example, and content data of the recommended content is received in response to an operation on the image, as will be described below. The emergency information can also be displayed as a card-shaped image. In the following description, the card information relating to the content information may be referred to as content card information and card information relating to emergency information is referred to as emergency card information to distinguish the two. That is, the content card information corresponds to content notification information for giving notification of content information, and the emergency card information corresponds to emergency notification information for giving notification of emergency information.

In a case in which emergency information and content information relating to at least a part of recommended content are output to the card generating unit 164 (e.g., in a case in which the emergency level is at level 2), the card organizing unit 162 may acquire associated content information that is content information relating to the emergency information (e.g., a news program reporting emergency information, a predetermined web page that provides details of the emergency information, or the like) and preferentially output the acquired associated content information over other content information. When content information relating to a news program is extracted, for example, the card organizing unit 162 extracts, from the content information that is input, content information including a phrase indicating the emergency situation included in the emergency information as associated content information. The card organizing unit 162 may read associated content information that has been stored in advance for a predetermined webpage, for example. The predetermined webpage is provided by a server apparatus that is used by main subjects that issue emergency information, for example, a local government, a fire station, a police station, a meteorological agency, and the like.

The card generating unit 164 uses the content information input from the card organizing unit 162 thereby generating content card information relating to each piece of the recommended content. The content card information at least includes information used to receive the recommended content. FIG. 10 is a diagram illustrating an example of content card information. The content card information illustrated in FIG. 10 is content notification information used to give notification on a program that is recommended content. The content card information includes a user ID, a title ID, a service type, a service ID, a display priority, a validity start time, a validity end time, a card display time block, and a recommendation type. The user ID is identification information of a user of the terminal apparatus 50, which is a transmission destination. The title ID is program identification information. The title ID is information corresponding to a program ID or a content ID. “Broadcast” in the service type indicates the service type which is “broadcast.” The service ID is a broadcast channel number, the program of which is broadcast. The display priority is a numerical value indicating a rank provided for the service type for each slot. The smaller the numerical value is, the higher the rank is. The validity start time and the validity end time indicate start time and end time of the validity period of the content card information, respectively. The card generating unit 164 defines the validity start time of the program as the broadcast start time of the program, and determines the validity end time to be a time that is later than the broadcast start time and before the broadcast end time (typically, a time at which the program has been broadcast for ½ to ¾ of the broadcast time after the start of broadcast). “20” in the card display time block is a value indicating 20:00 as the start time of a card acquiring unit time (which will be described below). In the above-described component information, the program ID, the broadcast start time, and the broadcast end time included in the program information (FIG. 5) may be used to determine a title ID, a validity start time, and a validity end time of the content card information, respectively.

Note that the content card information may include identification information of a slot, in place of or together with the card display time block. In addition, the content card information may include the title of the content, an image representing the content (representative image), and a message indicating summary thereof. The program information includes a title, a representative image, and a message, and the card generating unit 164 may fill their component information with one piece of the program information as a part of the content card information.

For a program for which the service type is reservation, the card generating unit 164 determines that the validity end time is a predetermined time (e.g., three minutes to one hour) before the broadcast start time of the program, without particularly providing the validity start time. For VOD content for which the service type is a VOD, the card generating unit 164 determines the validity start time and the validity end time to be a distribution start time and a distribution end time, respectively. In the content card information, the card generating unit 164 may describe the URL, which is an address of the content server apparatus that is the distribution source of the VOD content, in place of the service ID, and may omit the field of the broadcast type classification.

The card generating unit 164 arranges the generated content card information according to the rank of each service type in each slot added to the content information.

In a case in which emergency information is input to the card generating unit 164, emergency card information is generated using the emergency information. The emergency card information includes at least emergency information, for example, a part or all of the message illustrated in FIG. 7.

The card generating unit 164 stores, in the card accumulating unit 166, recommendation card information arranged according to the rank of each service type for each slot.

The card generating unit 164 may add additional information indicating a display mode of the emergency information to the emergency card information. The card generating unit 164 adds additional information indicating a more noticeable display mode as the emergency level of the emergency information becomes higher. In other words, the card generating unit 164 prescribes additional information indicating a format designating a display mode corresponding to the emergency level added to the emergency information. The noticeable display mode means being more prominent. The noticeable display mode may be, for example, a display region or an individual character or symbol being large, or a difference between a background and luminance or chromaticity being great. Also, increasing the display region of the emergency card information may be to occupy a display region for displaying content card information relating to some or all recommended contents, the output of which has been stopped by the card organizing unit 162.

In a case in which a size of the display region of the emergency card information is larger than a predetermined size, the card generating unit 164 may include, in the emergency card information, information indicating provision source of detailed information indicating the details of the emergency information. As the provision source, the address of a webpage of, for example, a local government, a fire station, a police station, a meteorological agency, or the like may be included in the emergency card information.

The card generating unit 164 stores the generated emergency card information in the card accumulating unit 166 at the highest rank in a predetermined service type of the slot at that time (e.g., the service type relating to the leftmost or rightmost edge of the display region of the terminal apparatus 50). In a case in which the display region of content card information relating to the recommended contents of a certain service type is occupied, the card generating unit 164 may further determine the rank of the service type to be the highest rank (first position) in the rank of the emergency card information, and store the rank information indicating the determined rank in addition to the emergency card information. This rank information makes it possible to identify the occupancy of emergency information in the display region of the content card information relating to the recommended content that is not to be outputted. An example of the emergency card information will be described below.

The card accumulating unit 166 stores the content card information arranged according to the determined rank of each service type for each slot. In addition, in a case in which the emergency card information is generated by the card generating unit 164, the emergency card information is stored in the highest rank of the predetermined service type of the slot at that time. The slot at that time refers to a slot including a time at that time or a slot in the next time block in the absence of such a slot. The card accumulating unit 166 receives a card information request from the terminal apparatus 50 via the communication unit 172 at every card acquiring unit time interval (e.g., 30 minutes to 3 hours). As a response to the card information request, the card accumulating unit 166 transmits, to the terminal apparatus 50, card information aggregated at that time for the card acquiring unit time by using the communication unit 172.

Note that the card acquiring unit time may be equal to that of a slot or a time of a multiple of a natural number of the slot.

In addition, the card accumulating unit 166 may observe (monitor) input of the emergency card information generated by the card generating unit 164, and may transmit the emergency card information to the terminal apparatus 50 via the communication unit 172 regardless of the input of the card information request when the emergency card information is input.

The communication unit 172 connects to the network NW and transmits and receives various types of data to and from another device connected to the network NW in a wireless or wired manner.

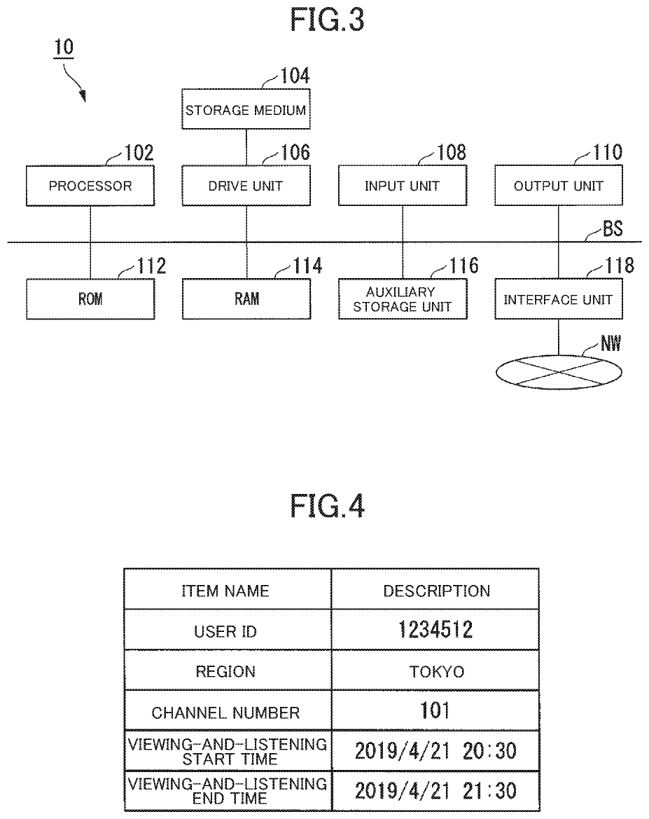

Next, an example of a hardware configuration of the information providing apparatus 10 according to the present embodiment will be described. FIG. 3 is a schematic block diagram illustrating an example of a hardware configuration of the information providing apparatus 10 according to the present embodiment.

The information providing apparatus 10 includes a processor 102, a storage medium 104, a drive unit 106, an input unit 108, an output unit 110, a Read Only Memory (ROM) 112, a Random Access Memory (RAM) 114, an auxiliary storage unit 116, and an interface unit 118.

The processor 102, the drive unit 106, the input unit 108, the output unit 110, the ROM 112, the RAM 114, the auxiliary storage unit 116, and the interface unit 118 are connected to one another using a bus BS. Thus, at least a portion of the information providing apparatus 10 is configured as a computer.

The processor 102, for example, reads programs and various types of data stored in the ROM 112 and executes the programs to control operation of the information providing apparatus 10. In this application, “executing a program” may mean executing processing indicated by an instruction (command) described in the program. The processor 102 is, for example, a Central Processing Unit (CPU).

The processor 102 executes a predetermined program to implement functional units of the received content information accumulating unit 142, the viewing-and-listening history accumulating unit 144, the recommendation target content information accumulating unit 146, the emergency information acquiring unit 148, the user preference information generating unit 152, the user preference information accumulating unit 154, the recommended content determining unit 156, the card organizing unit 162, the card generating unit 164, and the card accumulating unit 166.

The storage medium 104 stores various types of data. The storage medium 104 is a portable storage medium, for example, a magneto-optical disk, a flexible disk, a flash memory, or the like.

The drive unit 106 is, for example, a device that performs one or both of reading various types of data from the storage medium 104 and writing various types of data into the storage medium 104.

The input unit 108 is an input device configured to receive a user operation, generate an operation signal in response to the received operation, and outputs the generated operation signal to the CPU 102. The input unit 108 corresponds to, for example, a mouse, a keyboard, and the like. In the present application, operating according to information indicated by an input operation signal may be referred to simply as “operating in response to an operation.”

The output unit 110 is, for example, a display unit such as a display, a playback unit such as a speaker.

The ROM 112 stores, for example, a program to be executed by the CPU 102.

The RAM 114 temporarily stores, for example, various types of data and programs used by the CPU 102.

The auxiliary storage unit 116 is a storage medium such as a Hard Disk Drive (HDD), a flash memory, or the like. Note that storage media capable of storing various types of data and programs will be collectively referred to as a storage unit. The interface unit 118 enables other devices to be connected and to input and output various types of data in a wired or wireless manner. The interface portion 118 includes a communication module that connects to the network NW in a wired or wireless manner and allows other devices to be connected to the network NW to transmit and receive various types of data to and from one another. The interface unit 118 corresponds to the communication unit 172 described above.

Note that the emergency information server 20, the external server 30, and the terminal apparatuses 50 may each include a hardware configuration similar to that illustrated in FIG. 3.

### Terminal Apparatus

Next, an example of a functional configuration example of the terminal apparatus 50 according to the present embodiment will be described.

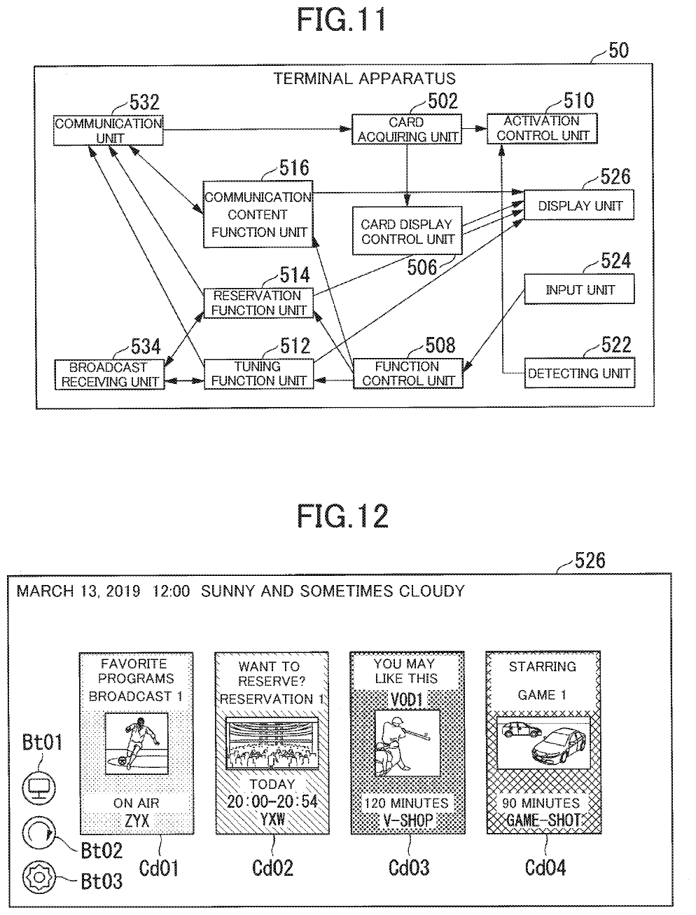

FIG. 11 is a block diagram illustrating an example of a functional configuration of the terminal apparatus 50 according to the present embodiment.

The terminal apparatus 50 includes a card acquiring unit 502, a card display control unit 506, a function control unit 508, an activation control unit 510, a tuning function unit 512, a reservation function unit 514, a communication content function unit 516, a detecting unit 522, an input unit 524, a display unit 526, a communication unit 532, and a broadcast receiving unit 534.

The card acquiring unit 502 transmits a card information request to the information providing apparatus 10 at every card acquisition unit time by using the communication unit 532. As a response to the card information request, the card acquiring unit 502 receives card information of the card acquisition unit time from the information providing apparatus 10, and stores the received card information.

The card acquiring unit 502 may observe (monitor) reception of the emergency card information from the information providing apparatus 10, regardless of transmission of the card information request. When receiving the emergency card information, the card acquiring unit 502 stores the received emergency card information at the highest rank of a predetermined service type of a slot at the time.

The card display control unit 506 controls processing for a received service of recommended content in response to an instruction to a displayed card. The card display control unit 506 reads, from the card acquiring unit 502, the card information of the slot, which is a time block to which the (current) time of control belongs. When the slot to which the current time belongs is updated in accordance with the elapse of time, the card display control unit 506 removes the card information of the slot before updating. Because the emergency card information is stored in the card acquiring unit 502 at the highest rank of the slot to which the time of control belongs, the emergency card information is preferentially read over the content card information.

The card display control unit 506 determines whether the current time is within the validity period notified by the card information. For card information determined to be within the validity period, the card display control unit 506 generates the image data for displaying the card information. For content card information, the card display control unit 506 generates image data representing information of the recommended content relating to the content card information. The generated image data includes an image having a shape of a card as an example. The information on recommended content includes information from which a user can visually identify an individual recommended content, for example, a title, a broadcast time or a playback time, a broadcast station name or a content provider name, and the like. The card display control unit 506 outputs to the display unit 526 the generated image data by a predetermined number for each service type of the recommended content. The display unit 526 displays an image representing information of the predetermined number of recommended content for each type of service. Each time an operation signal indicating switching is input from the input unit 524, the card display control unit 506 switches the image data representing the information of the recommended content to be output, according to ranks. The position of the image to be displayed by the display unit 526 on the display surface is predetermined for each service type, and the card display control unit 506 generates image data in which the image to be displayed is disposed at a position corresponding to the service type.

With respect to the emergency card information, the card display control unit 506 generates image data indicating the emergency information in a more prominent display mode as the emergency level included in the emergency card information becomes higher.

The card display control unit 506 defines, as a display mode, some or all of the size of a display region indicated by additional information included in the emergency card information, the size of an individual character and symbol, and the size of difference in luminance or chromaticity between the background and the display region. In other words, the card display control unit 506 identifies the display mode designated in a format indicated by the additional information included in the emergency card information.

The card display control unit 506 may reduce the number of pieces of the content card information, by which the image data is output, as the emergency level becomes higher, and include, in the display region of the emergency information, the display region of the image according to the image data, the output of which is stopped. The card display control unit 506 may stop outputting the image data relating to the content card information when the emergency level is at or above a predetermined level (e.g., level 3).

In a case in which the card display control unit 506 outputs image data relating to content information pertaining to emergency information and at least some of the recommended content (e.g., the emergency level is at level 2), the card display control unit 506 outputs the image data based on the associated content information described above as the content information.

For card information determined to be out of the validity period, the card display control unit 506 does not output the image data. In a case in which the card display control unit 506 already outputs the image data to the display unit 526 for the recommended content or emergency information, the card display control unit 506 stops the output. As a result, the image displayed in the display unit 526, which represents the recommended content or the emergency information, is deleted. The card display control unit 506 may output to the display unit 526 image data representing information of the recommended content or the recommended content at the next rank in emergency information.

The function control unit 508 causes a function unit corresponding to a service type of recommended content relating to an image that has been pressed to perform processing for eliciting the function for the service type. Pressing includes meanings that something is practically pressed and that the image input from the input unit 524 or a position of the image in the display region is indicated by an operation signal.

For example, the function control unit 508 outputs to the tuning function unit 512 content card information and an activation instruction of a program relating to the pressed image for broadcasting as a service type. The card information includes channel information as received information used to receive the program. In this way, the tuning function unit 512 starts performing a tuning process (which will be described below).

The function control unit 508 outputs, to the reservation function unit 514, the content card information and the activation instruction of the program relating to the pressed image for reservation as a service type. The content card information includes information of the channel and the broadcast time as received information used for reception of the program. In this way, the reservation function unit 514 starts performing a reservation process (which will be described below).

The function control unit 508 outputs, to the communication content function unit 516, card information and an activation instruction of the VOD content relating to the pressed image for VOD as a service type. The content card information includes acquisition source information such as a URL as received information used for the reception of the VOD content. The communication content function unit 516 starts performing a VOD reception process (which will be described later) when an activation instruction is input from the function control unit 508.

When activation is specified, the activation control unit 510 activates main function units of the terminal apparatus 50. That the activation is specified is equivalent to an input of a detection signal from the detecting unit 522 or an input of an operation signal indicating activation from the input unit 524. The activation control unit 510 includes, for example, a switch that controls whether power is to be supplied from a power source to each function unit. The main functions of the terminal apparatus 50 include a function unit required to achieve each function including broadcasting, reservation, and VOD, and more specifically, the card acquiring unit 502, the card display control unit 506, the function control unit 508, the tuning function unit 512, the reservation function unit 514, the communication content function unit 516, the input unit 524, the display unit 526, the communication unit 532, and the broadcast receiving unit 534.

The activation control unit 510 may stop operations of the main function units of the terminal apparatus 50 when no detection signal is input from the detecting unit 522 or when an operation signal indicating an operation stop is input from the input unit 524.

The activation control unit 510 and the detecting unit 522 may be capable of operating independently, with power being supplied during an operation stop of the main function units. For example, the activation control unit 510 and the detecting unit 522 are constituted of members (integrated circuits, sensors, and the like) that are separate from the main function units.

When an activation instruction is input from the function control unit 508, the tuning function unit 512 performs tuning process. More specifically, the tuning function unit 512 specifies a channel from the content card information input from the function control unit 508. The tuning function unit 512 causes the broadcast receiving unit 534 to receive a broadcast signal in a frequency band corresponding to the specified channel. The tuning function unit 512 separates video data from the broadcast signal received by the broadcast receiving unit 534, and outputs the separated video data to the display unit 526.

The reservation function unit 514 performs a reservation process when an activation instruction is input from the function control unit 508. More specifically, the reservation function unit 514 specifies the channel, the broadcast start time, and the broadcast end time from the content card information input from the function control unit 508. When the current time reaches the broadcast start time, the reservation function unit 514 causes the broadcast receiving unit 534 to start receiving the broadcast signal in the frequency band corresponding to the specified channel. The reservation function unit 514 separates the video data from the broadcast signal received by the broadcast receiving unit 534, and stores the separated video data. Note that, when the operation is stopped at the broadcast start time, the reservation function unit 514 may perform the reservation process upon activation.

When the current time reaches the broadcast end time, the reservation function unit 514 causes the broadcast receiving unit 534 to terminate reception of the broadcast signal. At the end of the reception, the reservation function unit 514 stops storing the video data. When an operation signal indicating playback is input from the input unit 524, the reservation function unit 514 outputs the stored video data to the display unit 526. Thus, the video of the stored program is displayed. Note that, after storage of the video data started in the reservation process is stopped, the reservation function unit 514 may stop the operation.

Note that the tuning function unit 512 and the reservation function unit 514 each create tuning information including a reception start time and a reception completion time as a viewing-and-listening start time and a viewing-and-listening end time. The tuning function unit 512 and the reservation function unit 514 further include the user ID set therein, regions in which these units are installed, and the channel number of the channel for reception, as part of the tuning information. The tuning function unit 512 and the reservation function unit 514 transmit the created tuning information to the information providing apparatus 10 and the external server 30 by using the communication unit 532.

The communication content function unit 516 performs a VOD reception process when an activation instruction is input from the function control unit 508. More specifically, the communication content function unit 516 specifies the acquisition source information from the content card information input from the function control unit 508. The communication content function unit 516 transmits via the communication unit 532 a VOD content request to the external server 30 indicated by the specified acquisition source information. The communication content function unit 516 receives, from the external server 30, VOD content data designated in the acquisition source information in response to the VOD content request. The communication content function unit 516 outputs to the display unit 526 video data included in the received VOD content data.

Note that the communication content function unit 516 generates VOD selection information including a reception start time and a reception end time, as a viewing-and-listening start time and a viewing-and-listening end time. The communication content function unit 516 further includes, as part of the VOD selection information, a user ID set therein, and a content ID received in association with the VOD content data. The communication content function unit 516 transmits the generated VOD selection information to the information providing apparatus 10 and the external server 30 using the communication unit 532.

The detecting unit 522 is installed on a housing surface of the terminal apparatus 50 and detects a person located within a predetermined range (e.g., 1 m) from the detecting unit. The detecting unit 522 includes, for example, a human sensor. The detecting unit 522 generates a detection signal indicating detection when a person is detected. The detecting unit 522 outputs the generated detection signal to the activation control unit 510.

The display unit 526 displays an image based on image data input from the card display control unit 506. In addition, the display unit 526 displays a video based on the video data input from each of the tuning function unit 512, the reservation function unit 514, and the communication content function unit 516. The display unit 526 includes, for example, a liquid crystal display, an organic Electro-Luminescence (EL) display, and the like.

The input unit 524 acquires an operation signal generated in accordance with a user operation, and outputs the acquired operation signal to the card display control unit 506. The input unit 524 may include, for example, an infrared interface for receiving an operation signal from a control apparatus (a remote control unit which will be referred to as a remote controller below), or may include a dedicated member, i.e., a button or the like for creating an operation signal in response to a user operation, a general member, i.e., a touch sensor, or the like. Instruction details given from operations are distinguished depending on operated buttons and specified positions.

The communication unit 532 transmits and receives various types of data to and from a device connected to the network NW. The communication unit 532 is a communication interface, for example.

The broadcast receiving unit 534 receives a broadcast signal transmitted from a broadcasting facility of a broadcast operator in a frequency band corresponding to the channel specified by the tuning function unit 512 or the reservation function unit 514. The broadcast receiving unit 534 is, for example, a tuner.

### Display Example

Next, an example of display of images representing information of recommended content information will be described.

FIG. 12 is a diagram illustrating an example of display of images representing information of recommended content.

Four card-shaped images Cd01 to Cd04 and three buttons Bt01 to Bt03 are displayed as images representing information of recommended content in the display region of the display unit 526. The images Cd01 to Cd04 are arranged from left to right in the middle of the display region.

The images Cd01 and Cd02 each are an image representing information of VOD content. The images Cd01 and Cd02 are showing, from the upper part to the lower part, messages, titles, screen shots, display times, and service provider names. A screen shot is a representative image representing one scene included in the video. The images Cd03 and Cd04 are images representing the information of programs, respectively. When the image Cd01 or Cd02 is pressed, the function control unit 508 causes the communication content function unit 516 to perform a VOD reception process for the VOD content relating to the pressed image.

The images Cd03 and Cd04 show, from the upper part to the lower part, messages, titles, screen shots, service offering statuses, and broadcast station names. The service type of the program represented by the image Cd01 is broadcast. The text string “on air” included in the image Cd01 indicates the program being broadcast at that time. When the image Cd01 is specified, the function control unit 508 causes the tuning function unit 512 to perform a tuning process for the program represented by the specified image. The service type of the program represented by the image Cd02 is reservation. The text string “today 20:00 to 20:54 p.m.” included in the image Cd02 indicates the scheduled broadcast time being from 20:00 to 20:45 of that day. When the image Cd02 is specified, the function control unit 508 causes the reservation function unit 514 to perform a reservation process for the program represented by the specified image.

The buttons Bt01, Bt02, and Bt03 are arranged in this order from left to right in a predetermined range from the lower left end of the display region of the display unit 526. The button Bt01 is a button for directing the terminal apparatus 50 to stop and activate a function at each time of direction. The button Bt02 is a button for directing display of an image representing content information at the next display rank as directed. An operation signal indicating switching is input to the card display control unit 506 in response to an instruction to the button Bt02. The button Bt03 is a button for displaying a menu screen as directed. The menu screen includes, for example, various settings screens, a screen for user guide, and the like.

The pressing may be detected by an operation signal from a touch sensor (not illustrated) mounted on a front surface or a back surface of the display region of the display unit 526, or may be detected by an operation signal from a remote controller (not illustrated). As an example, a remote controller having a cursor move button group and a selection button may be used. The cursor move button group includes four buttons for creating an operation signal to instruct a cursor to move in directions including up, down, left, and right directions when pressed. The function control unit 508 causes the display unit 526 to display a cursor indicating a position on the display region as instructed at that time, and moves the cursor in a direction as instructed by an operation signal input from the remote controller via the input unit 524. The selection button is a button for creating an operation signal to indicate a position represented by a cursor when pressed. The function control unit 508 performs a process for an image displayed at a position indicated by an input operation signal. Note that the remote controller may include one button corresponding to each of the images Cd01 to Cd04. Color of the buttons may be the same as that of the background of a corresponding image. The remote controller generates an operation signal indicating a corresponding image in response to pressing of a button. As described, in a case where a user presses a button having the same color as that of the background, the user can easily select the recommended content shown in the image as content for which reception of the service is desired.

### Emergency Card Information

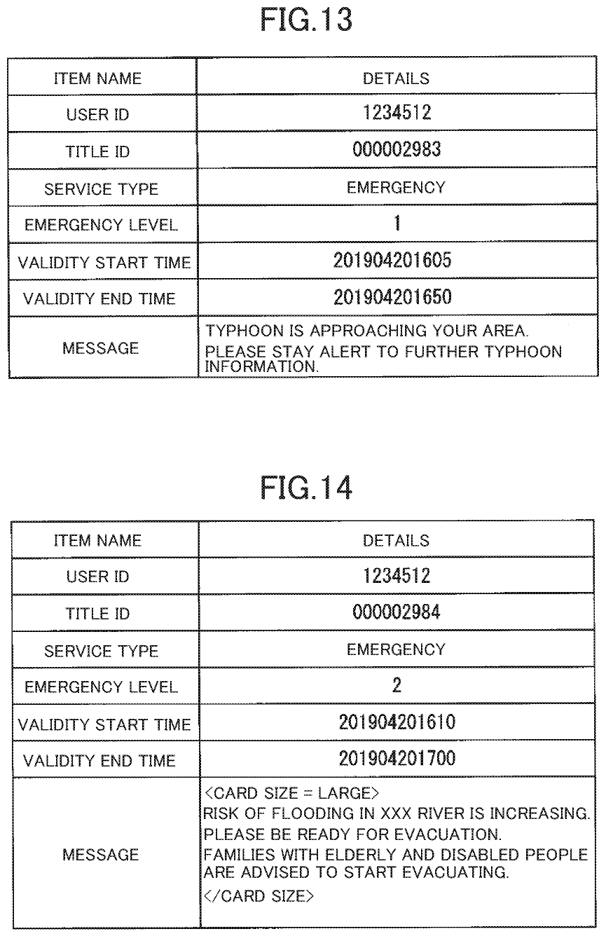

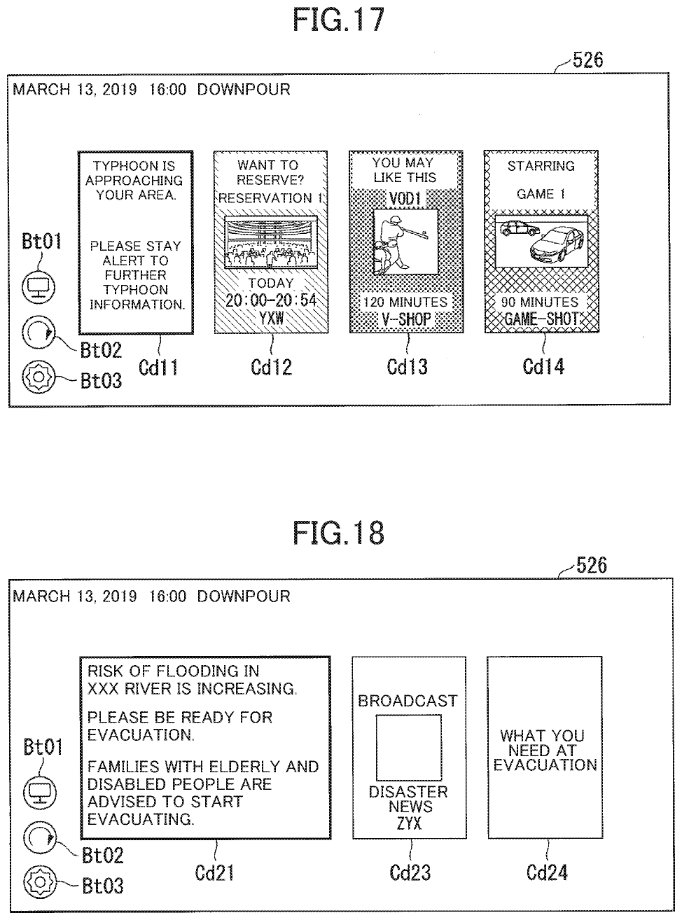

Next, an example of emergency card information according to the present embodiment will be described. FIG. 13 to FIG. 16 are diagrams illustrating examples of emergency card information. FIG. 17 to FIG. 20 are diagrams illustrating display examples of images representing emergency information based on the emergency card information illustrated in FIG. 13 to FIG. 16.

The emergency card information illustrated in FIG. 13 is an example of emergency card information generated based on the emergency information illustrated in FIG. 7. The emergency card information includes a user ID, a title ID, a service type, an emergency level, a validity start time, a validity end time, and a message, and is used to give notification of the emergency information described as the message. “1” is set as the emergency level.

The card generating unit 164 of the information providing apparatus 10 describes identification information of a user of the terminal apparatus 50, which is the transmission destination, in the item of the user ID, and describes emergency information or “emergency” indicating the notification thereof in the item of the service type. The card generating unit 164 describes information set to each item of the title ID, the emergency level, the validity start time, the validity end time, and the message of the emergency information, which is input, in each item of the title ID, the emergency level, the validity start time, the validity end time, and the message.

Note that, unlike content card information, item of “display priority” is not provided in the emergency card information. This is because emergency information is information to be notified with a higher priority than other content information.

The card generating unit 164 may not necessarily have to add additional information indicating a display mode to the emergency card information for the emergency information with an emergency level (“1” in the example of FIG. 13) set to be lower than a predetermined emergency level. In a case in which additional information indicating a display mode is not included the emergency card information, the card display control unit 506 of the terminal apparatus 50, which is a transmission destination, may generate image data indicating an image including the message of the emergency card information in the preset display mode, and output the generated image data to the display unit 526. As a preset display mode, a card-shaped image having a display region in the same size as that of the content card information and characters in the same typeface and the same size as those included in the content card information for characters expressing the message may be indicated. Further, the preset display mode may be more prominent than the display mode for the content card information. The card generating unit 164 of the information providing apparatus 10 may add, to the emergency card information, additional information indicating a display mode that is more prominent than the content card information.

FIG. 17 is a diagram illustrating a display example of an image representing emergency information based on the emergency card information illustrated in FIG. 13. Four card-shaped images Cd11 to Cd14 and three buttons Bt01 to Bt03 are displayed in the display region of the display unit 526. The image Cd11 is an image representing emergency information. A size of the display region of the image Cd11 is equal to a size of the display region of each of the images Cd12 to Cd14. In the image Cd11, the text string “Typhoon is approaching your area. Please stay alert to further typhoon information” which is a message of emergency notification information as emergency information is shown in the same size as the text strings included in the images Cd12 to Cd14.

Note that the images Cd12 to Cd14 corresponds to the images Cd02 to Cd04 illustrated in FIG. 12, and an image corresponding to the image Cd01 is not displayed in FIG. 17. In addition, the image Cd11 is displayed in a more prominent display mode than those of the images Cd12 to Cd14. More specifically, the image Cd11 is surrounded by a frame line that is thicker than those of the images Cd12 to Cd14 in a different color. This indicates that, by the card display control unit 506, the emergency card information relating to the image Cd11 is output preferentially over the content notification information of the image Cd01. As such, the user can access the emergency information preferentially over content information relating to the recommended content.

The emergency card information illustrated in FIG. 14 includes a user ID, a title ID, a service type, an emergency level, a validity start time, a validity end time, and a message. “2” is set as the emergency level. The message describes text information indicating emergency information “The risk of flooding in XXX river is increasing. Please bet ready for evacuation. Families with elderly and disabled people are advised to evacuate.” The text information is surrounded by the tag “<card size=large > . . . </card size>” as additional information indicating the size of the display region of the image, and is indicated to be disposed in a display region in the size indicated by the tag. The indicated size “large” indicates a display region in a predetermined size larger than a predetermined standard size, for example, the size that occupies two cards. The additional information is added by the card generating unit 164 based on the emergency level included in the emergency information input to the card generating unit 164 itself.

FIG. 18 is a diagram illustrating a display example of an image representing emergency information based on the emergency card information illustrated in FIG. 14. Three card-shaped images Cd21, Cd23, and Cd24 and three buttons Bt01 to Bt03 are displayed in the display region of the display unit 526. The image Cd21 is an image representing emergency information. The size of the display region of the image Cd21 corresponds to the size of an area occupying the display regions of both the image Cd23 and the image Cd24, which are two card-shaped images, also including the gap between the image Cd23 and the image Cd24. In the example illustrated in FIG. 18, the display region of the image Cd21 also includes a region between the image Cd23 and the image Cd24. The image Cd21 represents a text string representing a message of emergency notification information. As such, the user can perceive the provided emergency information more easily.

Note that the image Cd23 and the image Cd24 each represent associated content information relating to the emergency information notified by the image Cd21. The image Cd23 represents program information of a news program relating to the emergency information, and enables an operation to indicate the display of the video of the program. The image Cd24 represents content information relating to the web page for the emergency information, and allows an operation to indicate presentation of information published on the web page. The above-described associated content information is selected preferentially over other content information by the card organizing unit 162 of the information providing apparatus 10. As such, the user is promoted to viewing the associated content relating to the emergency information.

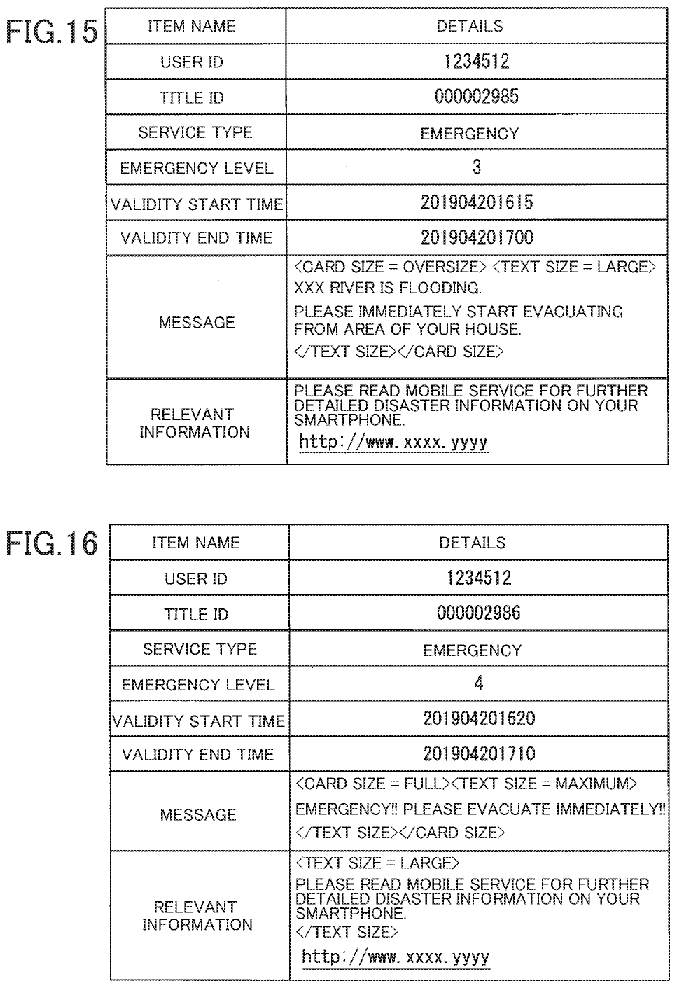

The emergency card information illustrated in FIG. 15 includes a user ID, a title ID, a service type, an emergency level, a validity start time, a validity end time, a message, and associated information. “3” is set as the emergency level. The message describes text information indicating the emergency information “XXX river is flooding. Please immediately evacuate from the area of your house.” The text information is surrounded by the tag “<text size=large > . . . </text size>” as additional information indicating the size of the text, and indicates that the text string of the text information is displayed in a larger size than predetermined standard text size. The text information is further surrounded by the tag “<card size=oversize> . . . </card size>” as additional information indicating the size of the display region of the image, and is instructed to be disposed within the display region. The indicated size “oversize” corresponds to a predetermined size that is larger than the size indicated by “large,” for example, the size occupying the display regions of each of the four cards. The additional information is added by the card generating unit 164 based on the emergency level.

The associated information includes a message as a guidance to provision of more detailed information relating to the emergency information including the wording “from now on, please check the mobile service for further detailed disaster information on your smart phone” and the URL “http://www.xxxx.yyyy” of the web server that is the providing source of the detailed information. The associated information may be extracted from the input emergency information and assigned to the emergency notification information by the card generating unit 164 of the information providing apparatus 10, or may be assigned to the emergency notification information from the associated information set in advance in the card generating unit 164.

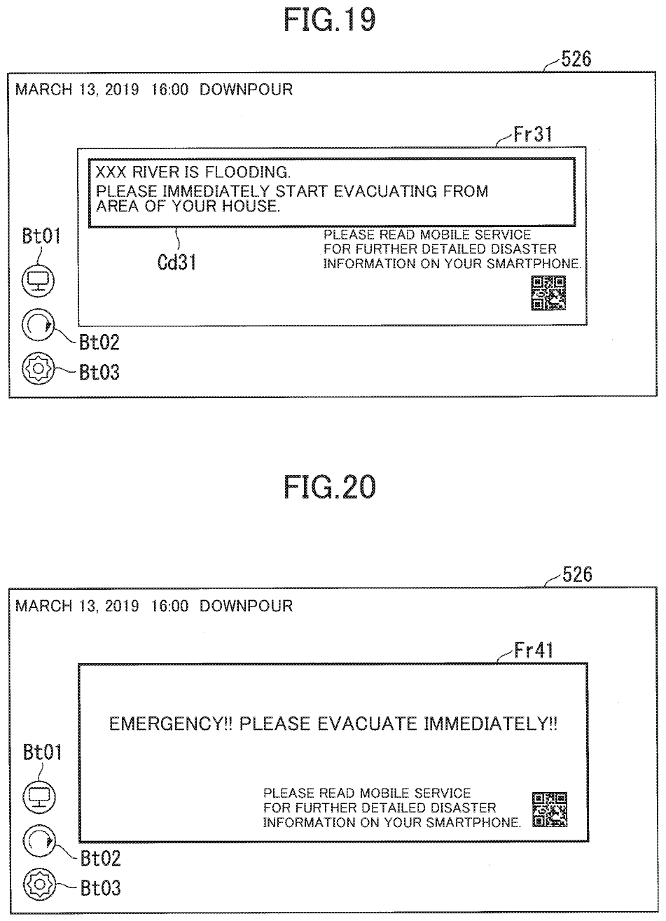

FIG. 19 is a diagram illustrating a display example of an image representing emergency information based on the emergency card information illustrated in FIG. 15. The display region of the display unit 526 includes a content display region Fr31, and a single card-shaped image Cd31 and three buttons Bt01 to Bt03 are displayed in the content display region Fr31. The image Cd31 is an image representing emergency information. The size of the display region of the image Cd31 corresponds to the area occupying the display regions of the four card-shaped images, and including the gaps between adjacent images. In the image Cd31, the text string representing the message of emergency notification information is shown in a larger size than in the example illustrated in FIG. 18. As such, the user can perceive the emergency information more easily. In addition, in the display region of the display unit 526, in a preset display region (hereinafter, referred to as a content display region Fr31) for displaying content such as various images, a message of the associated information and a barcode with a predetermined standard are shown in a region out of the range of the image Cd31. The barcode is an image generated by the card display control unit 506 by converting the URL of the providing source of the detailed information described in the associated information in accordance with a predetermined rule. An electronic device (not illustrated) including a photographing unit, a communication unit, and a display unit can capture an image of the barcode, reverse-convert the image-captured barcode into the URL, request the detailed information from the web server indicated by the URL obtained by the reverse conversion, and cause the display unit to display the detailed information received from the web server. The user of the terminal apparatus 50 carrying the electronic device can access the detailed information related to the emergency information by performing operation of capturing an image of the barcode. The standard of the barcode may be any of, for example, a one-dimensional code prescribed in JIS X 0502, JIS X 0503, or the like, a two-dimensional code prescribed in JEIDA-55, JIS X 0510, or the like.

The emergency card information illustrated in FIG. 16 includes a user ID, a title ID, a service type, an emergency level, a validity start time, a validity end time, a message, and associated information. “4” is set as the emergency level. The message describes text information indicating emergency information including the wording “emergency!! please evacuate immediately!!” The text information is surrounded by the tag “<text size=maximum> . . . </text size>” as additional information indicating the size of the text, and is indicated that the text string represented by the text information is displayed in a predetermined size that is larger than the size indicated by the text size “large.” The text information is further surrounded by the tag “<card size=full> . . . </card size>” as additional information indicating the size of the display region of the image, and is instructed to be disposed within the display region. The indicated size “full” indicates the entirety of the content display region Fr41. That is, it is indicated that a card that defines a portion of the content display region is not set. Associated information includes information similar to the associated information illustrated in FIG. 15. A message of the associated information includes additional information indicating the text size “large.” The additional information is added by the card generating unit 164 based on the emergency level. The card display control unit 506 may add a frame line to the outer edge of the content display region Fr41 of the generated image and display the image on the display unit 526.

FIG. 20 is a diagram illustrating a display example of an image representing emergency information based on the emergency card information illustrated in FIG. 16. A content display region Fr41 is included in the display region of the display unit 526, and three buttons Bt01 to Bt03 are displayed outside the range of the content display region Fr41. The content display region Fr41 is a region equivalent to the content display region Fr31 illustrated in FIG. 19, and is indicated by a frame line. A text string representing a message of emergency notification information is shown in the content display region Fr41 in a larger size than in the example illustrated in FIG. 19. Thus, the user can more easily perceive the emergency information. In addition, in the content display region Fr41, a message of the associated information and a barcode of a predetermined standard are shown in a region different from that of the message of the emergency notification information. The message of the associated information is represented with larger text than in the example illustrated in FIG. 19. Thus, the user is prompted to acquire more detailed information.

The activation control unit 510 of the terminal apparatus 50 may monitor whether emergency card information is newly stored in the card acquiring unit 502, and specify the emergency level included in the newly stored emergency card information. The activation control unit 510 activates the main function units when an operation of the main function units of the terminal apparatus 50 is stopped at that time and the specified emergency level is at or above a predetermined emergency level (e.g., emergency level “3”). Thus, even in a case in which the terminal apparatus 50 has stopped operating, notification on emergency information having a high emergency level is issued. Not all of the main function units may necessarily have to be activated, and it suffices that at least a notification function unit related to a notification of emergency information is included. The notification function unit may be a card display control unit 506, a function control unit 508, and a display unit 526. The notification function unit may include a playback unit (not illustrated) for playing sound. The activation control unit 510 may start playback of a predetermined warning sound when activation of the playback unit is indicated. The warning sound may be a sound that causes listeners to recognize occurrence of an emergency situation, for example, a siren sound, a buzzer sound, or the like. In a case in which the validity period of the emergency card information that has caused playback of a warning sound to start or the emergency level of the emergency information relating to the emergency card information is changed to less than the predetermined emergency level, the activation control unit 510 causes the playback unit to stop playing the warning sound.

Note that, although in the examples illustrated in FIG. 13 to FIG. 20, the card display control unit 506 specifies the display mode by referring to the additional information added to the emergency card information, and causes the display unit 526 to display an image representing the emergency information in the specified display mode, the disclosure is not limited thereto. The card display control unit 506 may independently determine a display mode without reference to the additional information such that display is more prominent as the emergency level included in the emergency card information becomes higher in the same manner as the card generating unit 164 of the information providing apparatus 10. For example, in the card display control unit 506, according to the size of the display region of the display unit 526, one or both of the size of the display region and the size of text of emergency information is preset for each emergency level. The card display control unit 506 may select, from the preset information, one or both of the size of a display region and the size of text corresponding to an emergency level included in the emergency card information to be input.

As described above, the information providing apparatus 10 according to the present embodiment is an electronic device including an information acquiring unit (e.g., the recommendation target content information accumulating unit 146 and the emergency information acquiring unit 148) that acquires content information indicating an attribute for each content, a notification information generating unit (e.g., the card generating unit 164) that refers to content information to generate content notification information that notifies of recommended content to be provided; and an output control unit (e.g., the card organizing unit 162) that controls output of the content notification information. In the information providing apparatus 10, when the information acquiring unit acquires emergency information, the output control unit outputs to the terminal apparatus 50 emergency notification information that notifies of the emergency information preferentially over content notification information.

In addition, the terminal apparatus 50 according to the present embodiment is an electronic device including a notification information acquiring unit (e.g., the card acquiring unit 502) that acquires content notification information that notifies of recommended content that can be provided from the information providing apparatus 10, and an output control unit (e.g., the card display control unit 506) that controls the notification of the recommended content based on the content notification information. In the terminal apparatus 50, when the notification information acquiring unit acquires the emergency notification information notifying of the emergency information, the output control unit outputs the emergency information preferentially over the notification of the recommended content.

With this configuration, when an electronic device that gives notification of the recommended content, which can be provided, acquires the emergency information, the emergency information is notified of preferentially over the recommended content. Thus, a user is prompted to respond to an emergency situation informed by the emergency information.

In the information providing apparatus 10, the notification information generating unit may add additional information indicating a more prominent display mode as the emergency level added to the emergency information of the emergency notification information becomes higher.

In the terminal apparatus 50, as the emergency level added to the emergency information becomes higher, the output control unit causes the display unit 526 to display the emergency information in a more prominent display mode.

A more prominent display mode may mean that a larger display region of the emergency information or larger text indicating the emergency information as the emergency level becomes higher.

With this configuration, the user can access the emergency information more easily as the emergency level becomes higher, and thus is prompted to respond to the emergency information.

In addition, the terminal apparatus 50 may include the activation control unit 510 configured to activate the output control unit when the emergency level added to the emergency information is higher than or equal to a predetermined level and an operation of the output control unit is stopped.

With this configuration, even if an operation of the output control unit is stopped, in a case in which the emergency level is above the predetermined level, notification on the emergency information is issued. Thus, the user can access to the emergency information more reliably.

Furthermore, in the terminal apparatus 50, when the emergency level added to the emergency information is higher than or equal to a predetermined level, the output control unit may cause the playback unit to output a warning sound.

With this configuration, in a case in which the emergency level is above the predetermined level, the warning sound is played. Thus, the user can access to the emergency information more reliably.

Also, the number of emergency levels is at least three, and when the emergency level is at a first level (e.g., level 1) or a second level that is one level higher than the first level (e.g., level 2), at least one recommended content may be notified, when the emergency level is at the second level, notification on associated content relating to emergency information of content to be provided may be preferentially issued, and when the emergency level is at or above a third level (e.g., level 3) that is higher than the second level, no notification on recommended content may be issued.

With this configuration, as the emergency level becomes higher, notification of recommended content is limited and access to the emergency information is encouraged. In addition, even if notification on content to be provided is issued, in a case in which the emergency level is at the second level, associated content relating to the emergency information is notified of preferentially, and information can be acquired through the associated content in addition to the emergency information.

Further, when the emergency level is at or above the third level, the emergency information may include detailed information providing information indicating a providing source of the detailed information indicating the details of the emergency information.

With this configuration, even when the display region is occupied by the emergency information, the user can acquire the detailed information from the providing source indicated by the detailed information providing information by using another electronic device.

An embodiment of the present disclosure has been described in detail above with reference to the drawings, but the specific configuration is not limited to the embodiment described above, and various design modifications and the like can be made without departing from the gist of the present disclosure.

Although the case in which the content to be processed is mainly a program and VOD content has been exemplified in the above-described embodiment, the present disclosure is not limited thereto. Other types of content may be processed. For example, electronic advertisements that can be transmitted and received via the network NW, and other various kinds of guide information may be subject to processing. Even for these contents, an image of the information is not displayed on the display unit 526 beyond the validity period, but is displayed within the validity period.

Further, one or both of the detecting unit 522 and the display unit 526 of the terminal apparatus 50 may be a separate body as long as various types of data can be transmitted to and received from other units of the terminal apparatus 50. A shape of an image displayed in the display unit 526 is not limited to a card shape. The shape may be another shape, for example, a button shape, a thumbnail shape, or the like. In addition, the number of images and details of service type can be set as desired.

In addition, in the above-described embodiment, a device ID identifying an individual terminal apparatus 50 may be used in place of a user ID. Further, although the example, in which the processing of each unit constituting the information providing apparatus 10 and the terminal apparatus 50 is performed for each individual terminal apparatus 50, has been described in the above-described embodiment, the present disclosure is not limited thereto. Processing of each unit may be performed individually by the user of each terminal apparatus 50. In this case, the detecting unit 522 of the terminal apparatus 50 identifies a user individually. The detecting unit 522 includes, for example, a photographing unit that captures an image of surroundings and an image processing unit that perform known image recognition processing on an image captured by the photographing unit to identify the user projected in the image.

A priority or a rank of each content may be predetermined by the external server 30, which is a providing source of content information, and the information may be added to content information. In addition, for each single content, the priority or the rank may be shared between multiple terminal apparatuses 50. In such cases, the received content information accumulating unit 142, the viewing-and-listening history accumulating unit 144, and the user preference information generating unit 152 may be omitted in the information providing apparatus 10.

Furthermore, the number of emergency information servers 20 is not limited to one, and may be multiple. Each of the constituent elements included in the external server 30 described above may be distributed or aggregated in any number of computing devices. For example, the program collection server, the VOD content collection server, the ranking server, and the VOD content server may be distributed or aggregated in any computer devices according to a network environment, the number of users, the number and specifications of hardware pieces provided to configure the information providing system 1, and the like. Some or all of the program collection server, the VOD content collection server, the ranking server, and the VOD content servers may be configured as an independent integrated server apparatus or may be integrated as a part of the information providing apparatus 10.

Note that each of the information providing apparatus 10, the emergency information server 20, the external server 30, the above-described server apparatus, and the terminal apparatus 50 may be implemented by a computer. In this case, a program for realizing the control function may be recorded on a computer-readable recording medium, and the program recorded on the recording medium may be loaded into a computer system and executed, whereby the implementation is achieved.

Furthermore, some or all of the information providing apparatus 10, the emergency information server 20, the external server 30, the server apparatus, and the terminal apparatus 50 described above may be realized as integrated circuits such as Large Scale Integration (LSI). Each functional block of some of the information providing apparatus 10, the emergency information server 20, the external server 30, the server apparatus, and the terminal apparatus 50 described above may be made into an individual processor, or some or all of the functional blocks may be integrated and made into processors. Furthermore, an integrated circuit technique is not limited to LSI, and each of the apparatuses may be realized as a dedicated circuit or a general-purpose processor. In addition, in a case in which a technology for further advancement in integration circuits emerges as a replacement for LSI due to enhancement in semiconductor technologies, an integrated circuit according to such technology may be used.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An electronic device comprising:
an information acquiring unit configured to acquire content information indicating an attribute of each content;
a notification information generating unit configured to generate content notification information notifying of recommended content that can be provided by referring to the content information; and
an output control unit configured to control output of the content notification information,
wherein, when the information acquiring unit acquires emergency information, the output control unit outputs emergency notification information notifying of the emergency information preferentially over the content notification information.

2. The electronic device according to claim 1,
wherein the notification information generating unit adds, to the emergency notification information, additional information indicating a more prominent display mode as an emergency level added to the emergency information becomes higher.

3. An electronic device comprising:
a notification information acquiring unit configured to acquire content notification information notifying of recommended content that can be provided;
an output control unit configured to control notification of the recommended content based on the content notification information,
wherein, when the notification information acquiring unit acquires emergency notification information notifying of emergency information, the output control unit outputs the emergency information preferentially over the notification of the recommended content.

4. The electronic device according to claim 3, further comprising an activation control unit configured to activate the output control unit when an emergency level added to the emergency information is at a predetermined level or higher and an operation of the output control unit is stopped.

5. The electronic device according to claim 3,
wherein, when an emergency level added to the emergency information is at a predetermined level or higher, the output control unit causes a playback unit to output a warning sound.

6. The electronic device according to claim 3,
wherein, as an emergency level added to the emergency information becomes higher, the output control unit causes a display unit to display the emergency information in a more prominent display mode.

7. The electronic device according to claim 2,
wherein, in the display mode, a display region of the emergency information is larger as the emergency level becomes higher.

8. The electronic device according to claim 2,
wherein, in the display mode, text indicating the emergency information becomes larger as the emergency level becomes higher.

9. The electronic device according to claim 2,
wherein the number of emergency levels is at least three,
when the emergency level is at a first level or a second level that is higher than the first level, notification on at least one piece of the recommended content is issued,
when the emergency level is at the second level, notification on relevant content relating to the emergency information of the content that can be provided is preferentially issued, and
when the emergency level is at or above a third level that is higher than the second level, notification on the recommended content is not issued.

10. The electronic device according to claim 9,
wherein, when the emergency level is at or above the third level, the emergency information includes detailed information providing information indicating a providing source of detailed information indicating details of the emergency information.

11. An information providing system comprising:
an information providing apparatus; and
a terminal apparatus,
wherein the information providing apparatus includes
an information acquiring unit configured to acquire content information indicating an attribute of each content,
a notification information generating unit configured to generate content notification information notifying of recommended content that can be provided by referring to the content information, and
an output control unit configured to control output of the content notification information,
when the information acquiring unit acquires emergency information, the output control unit outputs emergency notification information notifying of the emergency information preferentially over the content notification information,
the terminal apparatus includes
a notification information acquiring unit configured to acquire the content notification information; and
a terminal output control unit configured to control notification of the recommended content based on the content notification information, and
when the notification information acquiring unit acquires emergency notification information notifying of emergency information, the terminal output control unit outputs the emergency information preferentially over the notification of the recommended content.
